(19) United States
(12) Patent Application Publication
(10) Pub. No.: US 2017/0177820 A1
(43) Pub. Date: Jun. 22, 2017

(54) System and Device for Healthcare, Medical Information and Advertising Media Management

(71) Applicant: Jinliang Zhang, Baldwin Park, CA (US)

(72) Inventor: Jinliang Zhang, Baldwin Park, CA (US)

(21) Appl. No.: 15/452,565

(22) Filed: Mar. 7, 2017

(51) Int. Cl. G06F 19/00; G06K 9/00; G06Q 30/02; H04L 29/08; G06F 21/32

(52) U.S. Cl. CPC G06F 19/3418; H04L 67/12; G06F 19/322; G06F 21/32; G06F 19/328; G06Q 30/0277; G06K 9/00617; G06K 9/00288; G06K 9/00892

(57) ABSTRACT

A device for medical and healthcare management includes a main frame and a base extended from a bottom end of the main frame; a user identification arrangement arranged on the main frame to one-by-one identify user's information; a multimedia output arrangement arranged on the main frame to display and play texts, images, pictures, sound, animations, videos, and achieve other interactive functions; a health parameter detection arrangement arranged on the main frame and the base to detect various health parameters for the users; and a communication arrangement arranged on the main frame to communicate with external electronic devices.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a system and device for a healthcare, medical information, internet information and advertising media management.

Description of Related Arts

Nowadays, people pay more and more attention to their health. Conventionally, a health detection system is operated in a real-time manner, and the results and data are simply calculated, which is difficult to record the user's long-term health status, and provide lifestyle guidance for the users based on their health data. When the user has health problems, it is impossible for the conventional health detection system to remind the user to see a doctor and advise the user to purchase corresponding drugs based on the health data.

With the development of the intelligent mobile device technologies and internet technologies, current medical institutions and clinics have already digitized health data, but when the patient wants to make an appointment, only few information related to the doctors can be found, which becomes a long-existing problem. Therefore, the efficiency of the medical institutions and clinics is very low, and the patients are in a passive position when searching for medical treatments and lack of knowledge for the medical institutions and clinics, which may lead to a poor selection of appropriate medical institutions and clinics. Due to entry restrictions for medical resources and deficiency of connections between the patients and the doctors, it has lack of method and system to support the patients to cancel their appointments, so the doctors cannot use such spare time to provide service for more disease patients. And, if the patients want to leave their current medical institutions, the medical recourses of the patients cannot be completely transferred to other medical institutions. In order to solve the abovementioned problems, a device and system which can provide a platform to efficiently improve, modify, and integrate various medical information resources, and optimize clinic service processes, such as clinic queries, appointments, visits, payment, drug purchase, insurance purchase, and how to use the insurance. Therefore, the medical information and resources can be integrated and transmitted to mobile terminals to save time for the patients and improve medical services.

The purpose of the invention is monitoring the health data of the patients, tracking and managing their health, and at the same time, providing services of searching for the doctors, remote doctor consultations, payments, and insurances for an integrated health service. In other words, a real-time platform for providing and sharing the medical resources is created to improve the efficiency of medical treatment. Meanwhile, an improved market development in medical institutions and clinics can be achieved.

### SUMMARY OF THE PRESENT INVENTION

The invention is advantageous in that it provides a device for medical and healthcare management which is able to detect, monitor, and save health data of the user, and the user can directly communicate with medical institutions to process various medical activities through this device.

Another advantage of the invention is to provide a device for medical and healthcare management, wherein the device comprises a user identification arrangement which is adapted to identify user's personal information by account names, passwords, ID cards, phone numbers, social security number, fingerprints, etc.

Another advantage of the invention is to provide a system for medical and healthcare management, wherein the system can provide related medical staffs to conduct health data searching, mining, and managing, and the related medical staffs also can provide health information and data for people in need through this system.

Another advantage of the invention is to provide a system for medical and healthcare management, wherein the related medical staffs and users can compare and analyze health data through the system, and choose better and suitable medical treatments based on the analysis.

Additional advantages and features of the invention will become apparent from the description which follows, and may be realized by means of the instrumentalities and combinations particular point out in the appended claims.

According to the present invention, the foregoing and other objects and advantages are attained by a device for medical and healthcare management, comprising

a main frame and a base extended from a bottom end of the main frame;

a user identification arrangement arranged on the main frame to one-by-one identify user's information;

a multimedia output arrangement arranged on the main frame to display and play texts, images, pictures, sound, animations, videos, and achieve other interactive functions;

a health parameter detection arrangement arranged on the main frame and the base to detect various health parameters for the users; and

a communication arrangement arranged on the main frame to communicate with external electronic devices.

In accordance with another aspect of the invention, the present invention comprises a system for medical and healthcare arrangement, comprising:

a device for medical and healthcare management;

a user terminal communicated with the device;

a medical institution management terminal communicated with the device;

a medical staff terminal communicated with the health device;

a third party terminal communicated with the health detection device; and

a cloud data center communicated with the device.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a device for medical and healthcare management according to a preferred embodiment of the present invention.

FIG. 2 is a block diagram of a system for medical and healthcare management according to a second preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

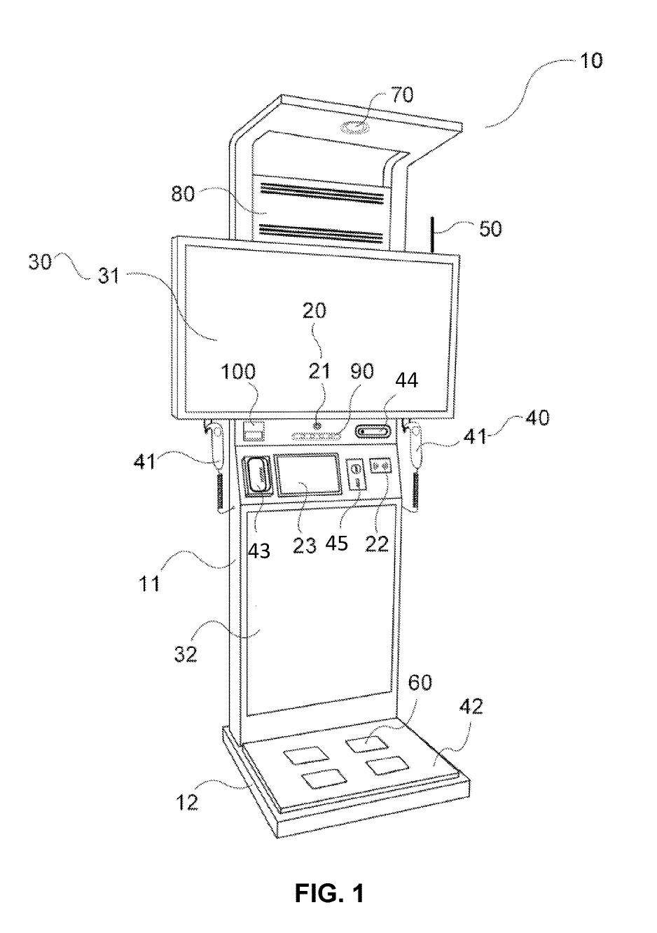

Referring to FIG. 1 of the drawings, a device 10 for medical and healthcare management according to a first preferred embodiment of the present invention is illustrated, wherein the device 10 comprises a main frame 11 and a base 12 transversely extended from a bottom end of the main frame 11 wherein the device further comprises a user identification arrangement 20 arranged on the main frame 11, at least one multimedia output arrangements 30 arranged on the main frame 11, a health parameter detection arrangement 40 arranged on the main frame 11, and a communication arrangement 50 arranged on the main frame 11, wherein the user identification arrangement 20 is adapted to identify user's information one-by-one; the multimedia output arrangements 30 are adapted to display and play texts, images, pictures, sound, animations, videos, and any other interactive means to communicate with the user; and the health parameter detection arrangement 40 is adapted to detect various health parameters of the user. It is worth to mention that the device can be, but not limited to a wearable device.

The user identification arrangement 20 comprises a camera module 21 to process facial and iris recognition module for the users, and the user identification arrangement 20 can further be applied to security and monitoring devices.

In one embodiment, the user identification arrangement 20 further comprises a touch sensor module 22, wherein the touch sensor module 22 can be, but is not limited to, a radio frequency identification module, a fingerprint recognition module, or a near field communication (NFC) module, so the user can use fingerprints, ID cards, or personal electronic device to be identified by the user identification arrangement 20.

In another embodiment, the user identification arrangement 20 further comprises a manually-input recognition module 23, wherein the manually-input recognition module 23 has a touch screen to allow the user to input user's names and passwords to login their accounts, and send their health data to their personal electronic devices, so the users can review their health parameters frequently. In addition, the users can also use their phone numbers or any other personal information, such as social security numbers or telephone numbers, to log into their health accounts.

The multimedia output arrangement 30 comprises at least one display module 31, 32. In one embodiment, the display module 31, 32 can be an advertisement display screen.

The health parameter detection arrangement 40 comprises a hand detection module 41 and a foot detection module 60 which can be adapted to detect personal health parameters from the users through their hands and feet. It is worth to mention that the hand detection module 40 and the foot detection module 60 can be, but is not limited to, a heart rate detection modules, a blood pressure measurement module 43, a blood glucose testing modules, a body temperature detection module 44 and a body composition detection module, or a combination of at least one or more of the above mentioned modules.

In one embodiment, the device 10 for medical and healthcare management further comprises a weight detection arrangement 42 arranged on the base 12 and communicated with the foot detection module 60, wherein the weight detection arrangement 42 is able to measure the user's weight. In another embodiment, the device 10 for medical and healthcare management may further comprise a height detection arrangement 70 which is adapted to use ultra-sound wave to detect the user's height.

The communication module 50 is able to send various health information of the users to other electronic devices, so the communication module 50 can be, but is not limited to, a cable jack module, a near field communication (NFC) module, a Bluetooth module, a ZigBee communication module, a RFID communication module, GSM, 3G, 4G LTE, 5G, or Wi-Fi communication module.

In a further embodiment, the device 10 further comprises an air purification arrangement 80 adapted to provide fresh air to the user, so when the user is being detected for his/her health parameters, he or she can be at the best condition. In still a further embodiment, the device 10 may further comprise a sensor module 90 to detect movements of the user for human-computer interactions. In still a further embodiment, the device 10 further comprises a printer 100 to print out the health parameters of the users. The device 10 may also include a coin-inserting device 45, so the user can activate the device by inserting coins.

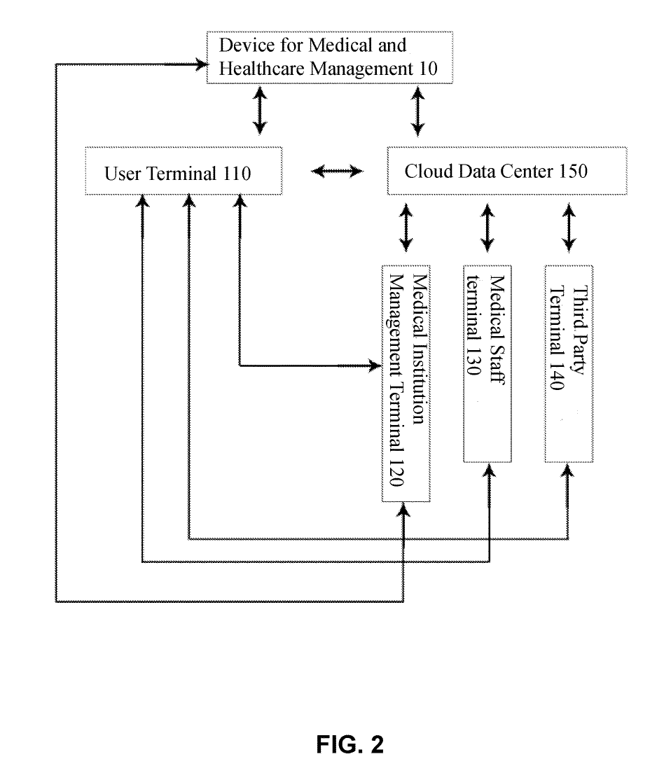

Referring to FIG. 2 of the drawings, a system incorporated with a device 10 for medical and healthcare management according to a second preferred embodiment of the present invention is illustrated, wherein the system comprises the device 10 for medical and healthcare management, a user terminal 110, a medical institution management terminal 120, a medical staff terminal 130, a third party terminal 140 communicated with the device 10, and a cloud data center 150, which can all be communicated with the device 10; wherein the device 10 is adapted to detect and track personal health parameters of the users, and the health data can be transmitted to the user terminals 110 and the cloud data center 150, and the device is configured to be a multimedia output device to display text, image, voice, animation and call-waiting.

In one embodiment, the user terminal 110 is a personal electronic device which is adapted to save and manage the users' health account, and the users are able to search doctors, make appointments, receive remote medical treatments, make payments, make purchases, purchase insurances, and obtain health information through the user terminal 110, and the user can use the user terminal 110 to shop online and to display simultaneously on said user terminal with the user's personalized data, user inspiration means, social interaction groups, online courses, offline services, and the user terminal has an external port to connect with an external device

The medical institution management terminal 120 is a software system or an electronic device to provide staffs in medical institutions and clinics to manage appointments, manage client information, make treatment plans, manage medical images of the patients, manage insurances, and communicate with the users.

The medical staff terminal 130 is an electronic device for the medical staffs, which is used to provide daily job management and industry trends searching, interact with other medical staffs, process academic discussions, experience process sharing, and perform mobile office functions for related medical staffs.

The third party terminal 140 is adapted to process data exchange between the device 10 and payment institutions, insurance agencies, medical institutions, medical imaging institutions, and blood testing institutions, etc.

The cloud data center 150 is adapted to save health data of the users and combine with the user's dietary and exercise habits to form an integrated data to efficiently monitor and track the user's health, and further provide the user guidance and reminders. And, the medical staffs and doctors can access the cloud data center to search the medical data for their patients.

In one embodiment, the user can purchase health insurance from the user terminal and according to the premium and insurance type, a reduction of medical expense is determined if the user is qualified for the reduction.

In another embodiment, the user can earn virtual currencies on the user terminal through daily exercise, and the virtual currencies can be used to purchase merchandise and service, participate in lottery or donation.

In a further embodiment, within a predetermined distance, the device for medical and healthcare management can deliver information to the user and the user can retrieve the information through the user terminal.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A device for medical and healthcare management, comprising:
a main frame and a base;
a user identification arrangement arranged on said main frame to identify user's information;
a multimedia output arrangement arranged on said main frame to display and play texts, images, pictures, sound, animations, videos, and other interactive means;
a health parameter detection arrangement arranged on said main frame and said base to detect various health parameters for the users; and
a communication arrangement arranged on said main frame to communicate with external electronic devices.

2. The device, as recited in claim 1, wherein said user identification arrangement comprises a camera module to process facial and iris recognition for the users.

3. The device, as recited in claim 1, wherein said user identification arrangement can be applied to security and monitoring devices.

4. The device, as recited in claim 1, wherein said user identification arrangement comprises a touch sensor module chosen from the group including an radio frequency identification module, a fingerprint recognition module, and a near field communication (NFC) module.

5. The device, as recited in claim 1, wherein said user identification arrangement comprises a manually-input recognition module, wherein said manually-input recognition module can be a touch screen to allow the user to log into their health accounts.

6. The device, as recited in claim 1, wherein said multimedia output arrangement comprises at least one display modules.

7. The device, as recited in claim 6, wherein each display module of said multimedia output arrangements comprise an advertising display module to display advertisements.

8. The device, as recited in claim 6, wherein the display module is configured to display waiting numbers for the users.

9. The device, as recited in claim 1, wherein said health parameter detection arrangement comprises a blood pressure measurement module, a blood glucose testing modules, a body temperature detection module, a height detection module, a hand detection module and a foot detection module.

10. The device as recited in claim 9, wherein the hand detection module and heart detection module detect the user's heart rate, blood glucose, bone density and body composition, and the foot detection module includes a weight detection arrangement arranged on the base and communicated with said foot detection module for measuring the user's weight.

11. The device, as recited in claim 9, wherein the height detection arrangement is arranged on said main frame to use ultra-sound wave to detect the user's height.

12. The device, as recited in claim 1, further comprising a communication module to send various health parameters of the users to other electronic devices, wherein said communication module includes a cable jack module, a near field communication (NFC) module, a Bluetooth module, a ZigBee communication module, a RFID communication module, GSM, 3G, 4G LTE, 5G, and Wi-Fi communication module.

13. The device, as recited in claim 1, further comprising an air purification arrangement adapted to provide fresh air to the user.

14. The device, as recited in claim 1, further comprising a sensor module to detect movements of the user for not only providing human-computer interactive recognition actions, but also activating and deactivating functions of the device.

15. The device, as recited in claim 1, further comprising a printer to print out health parameters of the users.

16. The device, as recited in claim 1, further comprising a coin-inserting device, so the user can activate the device by inserting coins.

17. A system for medical and healthcare arrangement, comprising:
a device for medical and healthcare management;
a user terminal communicated with said device;
a medical institution management terminal communicated with said device;
a medical staff terminal communicated with said health device;
a third party terminal communicated with said health detection device; and
a cloud data center communicated with said device,
wherein said device is adapted to detect and track personal health data of the users, and the health data are transmitted to said user terminals and said cloud data center, and the device is configured to be a multimedia output device to display text, image, voice, animation and call-waiting,
wherein said user terminal is a personal electronic device to save and manage the users' health accounts, and the users are able to search doctors, make appointments, receive remote medical treatments, make payments, purchase insurances, manage patients' medical histories, receive examination report, self-diagnose via the internet, and obtain exercise, nutrition and health information through said user terminal, and the user can use the user terminal to shop online and to display simultaneously on said user terminal with the user's personalized data, user inspiration means, social interaction groups, online courses, offline services, and the user terminal has an external port to connect with an external device,
wherein said medical institution management terminal is a software system or an electronic device to provide staffs in medical institutions and clinics to manage appointments, manage client information, make treatment plans, manage medical images of the patients, manage insurances, generate electronic medical histories, issue electronic prescriptions, search medical information online, and connect with third parties,
wherein said medical staff terminal is an electronic device for the medical staffs to provide daily job management and industry trends searching, interact with other medical staffs, process academic discussions, experience process sharing, perform mobile office functions for related medical staffs, conduct remote diagnosis, manage patients, search medical documentation, provide online search for medical information, and establish mobile medical examination rooms,
wherein said third party terminal includes both software and hardware that is set up at payment institutions, insurance agencies, medical institutions, medical imaging institutions, and blood testing institutions, etc. to process data exchange between the cloud data center and the user terminal, the medical institution management terminal and the medical staff terminal,
wherein said cloud data center is adapted to save health data of the users and combine with the user's dietary and exercise habits to form an integrated data to efficiently monitor and track the user's health, and when any abnormal health conditions of the user is detected, a warning message will be sent to the user, the user's family doctor or the user's guardian.

18. The system of claim 17, wherein the user can purchase health insurance from the user terminal and according to the premium and insurance type, a reduction of medical expense is determined if the user is qualified for the reduction.

19. The system of claim 17, wherein the user can earn virtual currencies on the user terminal through daily exercise, and the virtual currencies can be used to purchase merchandise and service, participate in lottery or donation.

20. The system of claim 17, wherein within a predetermined distance, the device for medical and healthcare management can deliver information to the user and the user can retrieve the information through the user terminal.
